(19) United States
(12) Patent Application Publication
(10) Pub. No.: US 2008/0150892 A1
(43) Pub. Date: Jun. 26, 2008

(54) COLLECTION BROWSER FOR IMAGE ITEMS WITH MULTI-VALUED ATTRIBUTES

(75) Inventors: JONATHAN ANTHONY DUHIG, New South Wales (AU); Simon Liddington, New South Wales (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/952,677

(22) Filed: Dec. 7, 2007

(30) Foreign Application Priority Data
Dec. 21, 2006 (AU) 2006252190

(51) Int. Cl. G09G 5/00

(52) U.S. Cl. 345/156

(57) ABSTRACT

Disclosed is a method and interface for browsing a collection (201) of images (203-208) represented (200) on a display device (100, 314). The interface provides an ordered arrangement (201) of the images according to at least one specific attribute (Person) of the images. At least one of the images (205) has multiple values (Fred, June) for the one attribute and the one image appears in the arrangement at a first position (between 202-208) corresponding to a first (Fred) of the values and at least one second position (between 210-215) corresponding to at least a second (June) of the values. The method displays at least a first subset (202-208) of the arrangement of images on the display device, the first subset including the one image at the first position. The interface responds to a user action upon an input device to cause display on the display device of a second subset (210-215) of the arrangement of images including the one image (205) at the second position.

### CROSS-REFERENCE TO RELATED PATENT APPLICATIONS

This application claims the right of priority under 35 U.S.C. § 119 based on Australian Patent Application No. 2006252190, filed Dec. 21, 2006, which is incorporated by reference herein in its entirety as if fully set forth herein.

### TECHNICAL FIELD

The present invention relates to the presentation of items in a collection and, in particular, to browsing a collection of images where items in the collection may have multiple values associated with one or more attribute types.

### BACKGROUND

With the advent and huge popularity of image scanners, video capture cards, digital still and video cameras, digital music players and recorders, it is common for people to store a large number of photographs on personal computers and other computer related devices. There is a need for users of these devices to be able to access and navigate through their collections to view items and to visually search for items.

Traditionally, images stored on personal computers use a hierarchical folder or directory structure. Images which are related are stored together in a folder which may be named by the user to indicate the manner in which the items are related. Where image items in a folder may be grouped into smaller sets, the user may create sub-folders for these items.

Using folders to store large collections of image items is problematic, as there are many ways in which the user may organise their collections into folders. This is generally because image items have more than one attribute type. Attributes are a means by which ancillary data or metadata regarding the item may be retained with the image item, but generally distinct from the actual image content. For example, for a collection of photographs, the user could name their folders by the date the photographs were taken, or by the location at which the photographs were captured, or by the people or other content in the photographs. No single folder naming system or method of collection organisation is ideal.

To alleviate this problem, mechanisms for associating attributes or metadata with image items have arisen. This allows a collection browser to present the user with a variety of the collection organisations available via the stored attributes.

Many prior art image collection browsers which take advantage of attributes, present the collection as folders named according to the attribute values, often organised into a hierarchy. Items with more than one value for an attribute, such as a photograph with more than one person in it or the same musical tracks on different albums, may therefore be found in more than one “folder” in such a presentation of the collection.

Prior art collection browsers have a number of disadvantages. Significantly, the user cannot scroll through the image collection as a whole, as the user is forced to navigate via the folder hierarchy in order to see all images in the collection. Also, when the user is looking at an image in one folder, and the user wishes to view items related to it by an attribute value other than the one relating to the current folder, the user must navigate up the folder hierarchy and back down to the folder corresponding to the attribute value within which they have interest.

### SUMMARY

In accordance with one aspect of the present invention, there is disclosed a method of browsing a collection of images represented on a display device, said method comprising the steps of:

(i) providing an ordered arrangement of the images according to at least one specific attribute of the images wherein at least one of the images has multiple values for the at least one attribute and the one image appears in the arrangement at a first position corresponding to a first of the values and at least one second position corresponding to at least a second of the values;

(ii) displaying at least a first subset of the arrangement of images on the display device, the first subset including the one image at the first position; and

(iii) responding to a user action upon an input device to cause display on the display device of a second subset of the arrangement of images including the one image at one the second position.

Typically the user action relates to a directional movement and step (iii) comprises scrolling the display progressively through the arrangement of the images from the one image at the first position to the one image at one the second position.

The user action may relate to a jump function and step (iii) comprises changing the display substantially instantaneously from a display of the first subset of images to a display of the second subset of images. The changing of the display can be instantaneous or an automated fast animated traversal from the first subset to the second subset of images. The ordered arrangement may comprise a circular list.

The method may further comprise displaying, in association with the one image on the display device, a representation of values of the attributes associated with the one image. Desirably the representation of the values forms a user selectable menu via which a value of one the attribute is selectable by the user action for the one image.

A collection or set of image items is arranged on a display device according to an attribute type, for example as an ordered list. With a large collection of images, the display device shows a subset of the collection, which could be considered a window into the ordered arrangement. The user is able to scroll through the collection as a whole by moving this window through the collection by use of an input device. The scrolling causes the progressive display of images in the ordered arrangement. Scrolling may step through only part of the collection, for example, progressing only by one image, or may traverse the entire collection.

Where an image has multiple values for an attribute type, the image is represented at multiple positions in the arrangement, each position corresponding to each attribute value. For such an item visible on the display, through the use of an input device, the user may cause the display to jump to other positions in the arrangement corresponding to other attribute values in order to quickly view other items with the same attribute value.

The user may also wish to view image items with attribute values of a different attribute type. In this case, the input device may be used to cause the display to show an arrangement organised according to the new attribute type at position corresponding to the attribute value of interest.

The presently disclosed arrangements have the advantages of allowing the user to browse the image collection as a whole as well as being able to quickly view items related by any common attribute value to a currently visible item.

### BRIEF DESCRIPTION OF THE DRAWINGS

One or more embodiments of the present invention will now be described with reference to the drawings, in which:

FIG. 1 is a system diagram showing a typical digital system for the reproduction of image items;

FIG. 2A is an example of a collection browser application showing an ordered list and an attribute value selection list;

FIG. 2B is an example of a collection browser application showing an ordered list in an alternative position to FIG. 2A and an attribute value selection list;

FIG. 2C is an example of a collection browser showing an ordered list with a different ordering to FIGS. 2A and 2B and an attribute value selection list;

FIG. 3 is a schematic block diagram representation of a general purpose computer system within which the disclosed arrangements may be practiced;

FIG. 4 illustrates functional operation according to the present disclosure;

FIG. 5 illustrates an organizational structure for a collection of image items as manipulated and represented using a browser according to the present disclosure; and

FIG. 6 is a flowchart of a method of browsing an ordered collection of image items.

### DETAILED DESCRIPTION INCLUDING BEST MODE

Disclosed is a method for browsing a collection of image items stored in a digital system. The image items may include still images (such as bitmap or graphic), and video (such as movies or animations). The actual storage of such image collections in digital systems is well known. Image items are typically stored in a hierarchical file system or a database structure on a storage medium such as a hard disk, optical disk or random access memory (RAM). Such storage may be accessible via a computer or communications network.

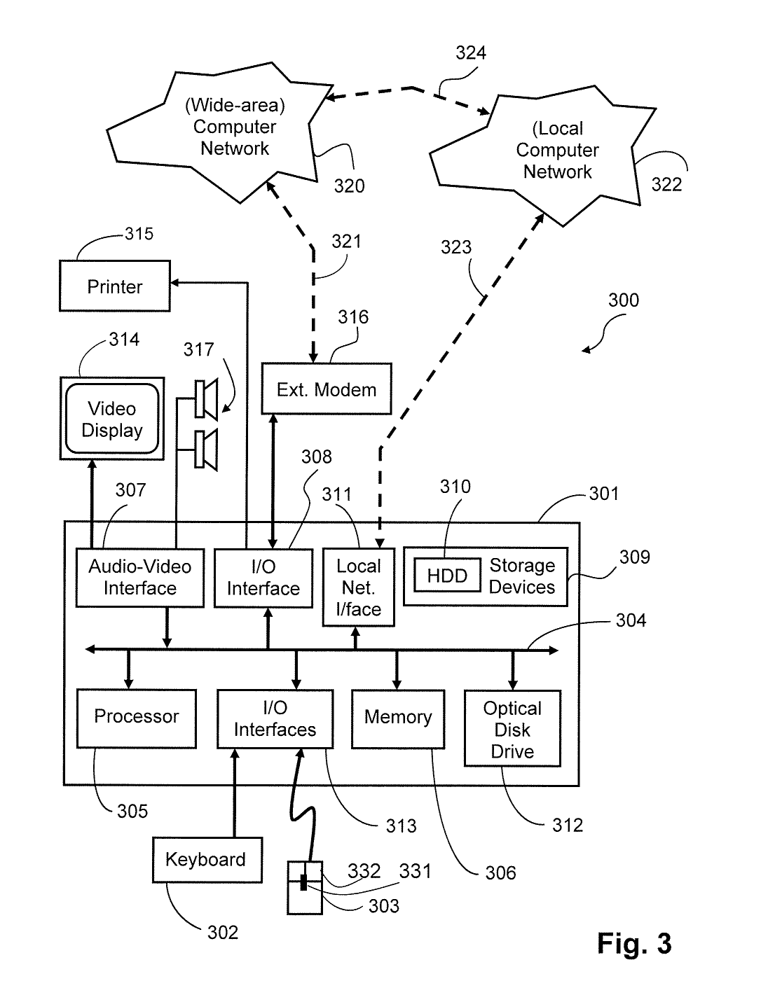

The methods of browsing a collection of image files or items to be described may be practiced using a general-purpose computer system 300, such as that shown in FIG. 3 wherein the processes to be described with reference to the remaining figures may be implemented as software, such as an application program executing within the computer system 300. In particular, the steps of the browsing methods are effected by instructions in the software that are carried out by the computer. The instructions may be formed as one or more code modules, each for performing one or more particular tasks. The software may also be divided into two separate parts, in which a first part performs the actual browsing and searching methods, and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for browsing a collection of data items.

As seen in FIG. 3, the computer system 300 is formed by a computer module 301, input devices such as a keyboard 302 and a mouse pointer device 303, and output devices including a printer 315, a display device 314 and loudspeakers 317. An external Modulator-Demodulator (Modem) transceiver device 316 may be used by the computer module 301 for communicating to and from a communications network 320 via a connection 321. The network 320 may be a wide-area network (WAN), such as the Internet or a private WAN. Where the connection 321 is a telephone line, the modem 316 may be a traditional “dial-up” modem. Alternatively, where the connection 321 is a high capacity (eg: cable) connection, the modem 316 may be a broadband modem. A wireless modem may also be used for wireless connection to the network 320.

The computer module 301 typically includes at least one processor unit 305, and a memory unit 306 for example formed from semiconductor random access memory (RAM) and read only memory (ROM). The module 301 also includes an number of input/output (I/O) interfaces including an audio-video interface 307 that couples to the video display 314 and loudspeakers 317, an I/O interface 313 for the keyboard 302 and mouse 303 and optionally a joystick (not illustrated), and an interface 308 for the external modem 316 and printer 315. In some implementations, the modem 316 may be incorporated within the computer module 301, for example within the interface 308. The computer module 301 also has a local network interface 311 which, via a connection 323, permits coupling of the computer system 300 to a local computer network 322, known as a Local Area Network (LAN). As also illustrated, the local network 322 may also couple to the wide network 320 via a connection 324, which would typically include a so-called “firewall” device or similar functionality. The interface 311 may be formed by an Ethernet™ circuit card, a wireless Bluetooth™ or an IEEE 802.11 wireless arrangement. The keyboard 302 and the mouse 303 may be coupled to the computer module 301 by corresponding wired connections, or using wireless connections, such as radio frequency or infra-red connections, as illustrated by the corresponding dashed lines in FIG. 3.

The interfaces 308 and 313 may afford both serial and parallel connectivity, the former typically being implemented according to the Universal Serial Bus (USB) standards and having corresponding USB connectors (not illustrated). Storage devices 309 are provided and typically include a hard disk drive (HDD) 310. Other devices such as a floppy disk drive and a magnetic tape drive (not illustrated) may also be used. An optical disk drive 312 is typically provided to act as a non-volatile source of data. Portable memory devices, such optical disks (eg: CD-ROM, DVD), USB-RAM, and floppy disks for example may then be used as appropriate sources of data to the system 300.

The components 305, to 313 of the computer module 301 typically communicate via an interconnected bus 304 and in a manner which results in a conventional mode of operation of the computer system 300 known to those in the relevant art. Examples of computers on which the described arrangements can be practised include IBM-PC's and compatibles, Sun Sparcstations, Apple Mac™ or alike computer systems evolved therefrom.

Typically, the application programs discussed above are resident on the hard disk drive 310 and read and controlled in execution by the processor 305. Intermediate storage of such programs and any data fetched from the networks 320 and 322 may be accomplished using the semiconductor memory 306, possibly in concert with the hard disk drive 310. In some instances, the application programs may be supplied to the user encoded on one or more CD-ROM and read via the corresponding drive 312, or alternatively may be read by the user from the networks 320 or 322. Still further, the software can also be loaded into the computer system 300 from other computer readable media. Computer readable media refers to any storage medium that participates in providing instructions and/or data to the computer system 300 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 301. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 314. Through manipulation of the keyboard 302 and the mouse 303, a user of the computer system 300 and the application may manipulate the interface to provide controlling commands and/or input to the applications associated with the GUI(s). Generally the GUIs include icons or regions that, when appropriately selected using either or both of the keyboard 302 and mouse 303, provide for user control of the application program to achieve a desired function. Particularly, the mouse 303 typically affords two-dimensional positioning within a GUI and selection at a determinable location via user actuable switches 332 formed therein. In some instances the mouse 303 includes a scroll wheel 331 which, which actuated by the user, permits content within the GUI to be scrolled.

Whilst the computer system 600 may be used to implement the browsing arrangements to be described, such may also be configured in more specific user devices of smaller size or limited application. Such specific user devices include, but are not limited to, portable/personal audio and/or video reproduction devices, for example utilizing MP3 or MPEG file formats.

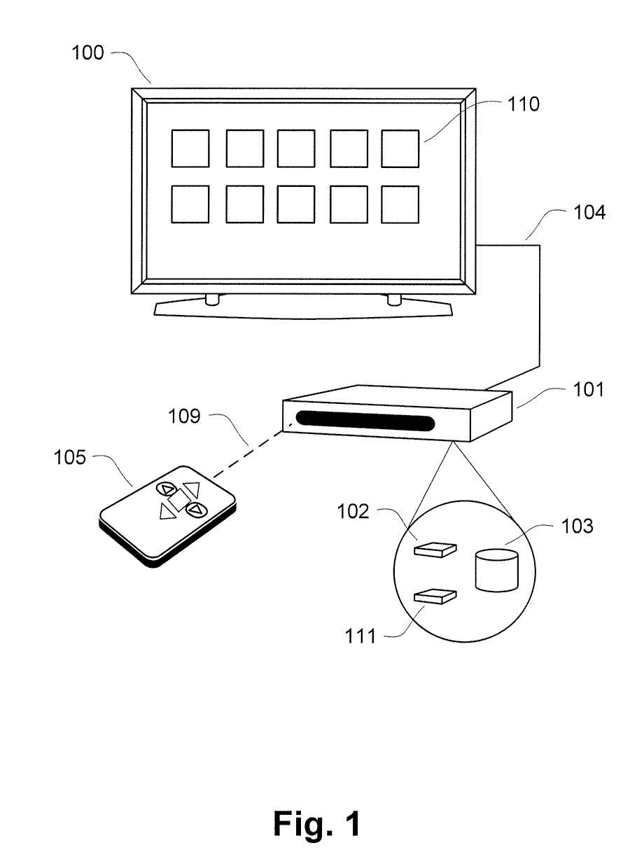

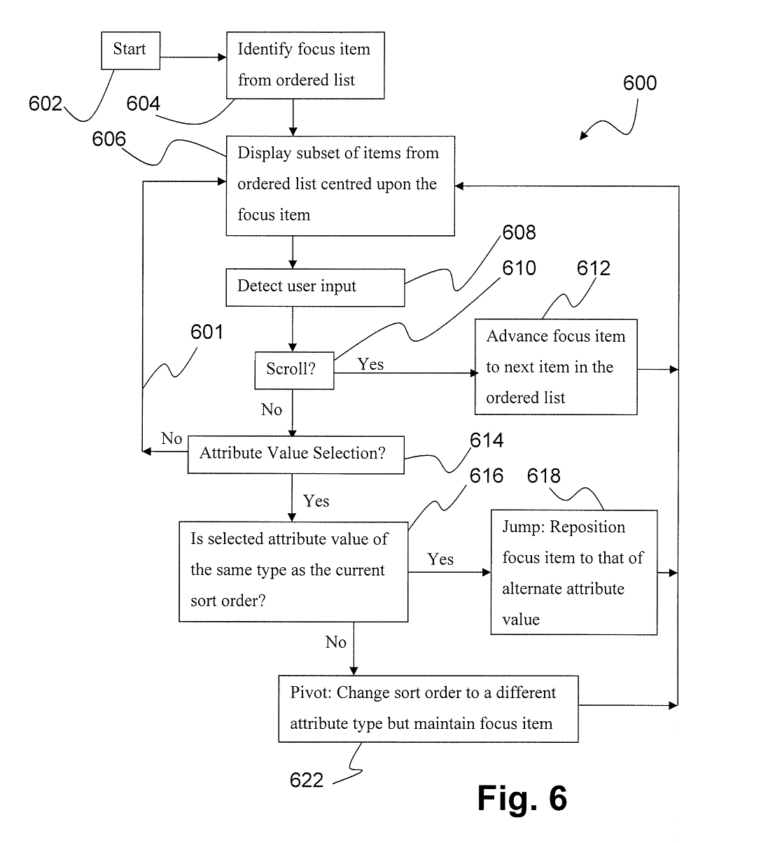

FIG. 1 shows a digital system having a display 100 connected to a media device 101 by a connector 104. This connector may use wires or be wireless using radio or infrared signal. The media device 101 comprises at least a Central Processing Unit (CPU) 102 and a data storage system 103, typically configured in a manner akin to corresponding components of the computer 601 of FIG. 6 described above. The media device 101 may be a dedicated reproduction device, a device with additional capabilities such as a TV tuner, a set-top box, or a DVD player, or may be a general purpose Personal Computer (PC). The media device 101 may additionally contain a Graphics Processing Unit (GPU) 111 which is configured to assist in the rendering of a graphical user interface 110 to the display 100. The GPU 111 may support the execution of graphics libraries such as OpenGL, a registered trade mark of certain products manufactured by Silicon Graphics, Inc of U.S.A. The data storage system 103 typically stores a plurality of items represented in digital form. Alternatively, in network configured arrangements, such as a CATV set-top box arrangement, the device 101 may provide access via the network to the stored items.

An application program operating in accordance with the present disclosure and executed by the CPU 102, optionally assisted by the GPU 111, causes the user interface 110 to be rendered upon the display 100.

A control device 105, illustrated as a hand-portable remote control, is operable by a user to transmit a signal 109 to the media device 101, wherein the signal is received by the CPU 102 and causes control events to occur which may result in changes to the state of the digital system and to the user interface 110 represented upon the display 100. The signal 109 may be an infra-red signal or a radio signal or alternatively the control device 105 may also be connected by one or more wires or may be integrated into the media device 101. The control device 105 may alternatively be a standard input device such as a keyboard or mouse, akin to those described above.

In some implementations, the Central Processing Unit (CPU) 102, the optional Graphics Processing Unit (GPU) 111 and the data storage system 103 may be contained directly within the chassis of the display 100, thereby eliminating the need for the media device 101 and the connector 104. In other implementation, the display 100 may be portable. Further, the functional components of the device 101 may be included in a device with additional capabilities, for example a digital camera, with the user interface 110 being rendered either on a display which is integrated into the device, or on an external display. Some components and user controls may be shared between the browsing application and any additional capabilities of the device.

FIG. 4 shows a simplified representation of two instances 400A and 400B of a browser display according to the present disclosure comprising a collection or set 401 of photographs in which an attribute associated with the collection 401 is the name of a subject of the photograph. Based upon the attribute, the images in the collection 401 are arranged as an ordered list, in this case ordered according to a name associated with each photograph. The browser interface displays 400A and 400B may be represented upon the display devices 100 or 314, depending upon the particular implementation, and are controllable by the user with the corresponding input device(s) 105 or 302 and 303. A scrollable browsing representation of the items of the collection 401 is shown in a “film strip” fashion, including a single row of images representing a portion or segment of the entire list of images. The images as displayed within the interface are scrollable, to permit the user to browse the collection. In one implementation the scrollable list has ends representing (in this case) a commencement of the name ordering and an end of the name ordering, permitting the user to scroll from one end to the other, and back again, as desired. In an alternate implementation, the list may be arranged in a circular fashion so that the entire collection may be browsed by scrolling in either direction.

In a first instance 400A, the image items represented in the interface include a group of photographs 402 of Janet and, in a second instance 400B, the items represented include a group of photographs 404 of John. The image items as represented in the interface 400A, 400B are typically relatively low resolution “thumbnail” type images which may be used to access the corresponding full resolution images. Specifically two photographs 406 and 408 of Janet are identified and two photographs 408 and 410 of John, amongst others, are identified in the respective instances. Note that the photograph 408 is common to each of the groups 402 and 404. Each of the representations 400A and 400B are scrollable whereby, for example, through user action the user may scroll through the list of items in the collection 401 from the representation 400A to the representation 400B, and vice versa. Further, whilst the particular collection of images may have only one image 408, the image 408 is represented twice (ie. is duplicated) in the ordered list as a consequence of it being associated with each of the attributes Janet and John. As such, a single unidirectional browse of the entire collection 401 within the present interface will encounter the image 408 twice. Further, depending upon the number of images in the collection and the attribute values associated with duplicated images, it is possible that one representation of the browser interface may simultaneously show two or more instances of the same thumbnail image representation. This may occur, for example, with a photograph containing both Aragon and Aristotle.

According to the present disclosure, a jump function, schematically represented at 412, permits the browser display to jump from the representation 400A, substantially instantaneously to the representation 400B, and vice versa when an appropriate user selection is made. This permits the browser, having identified that the photograph 408 has multiple values (ie. “Janet” and “John”) for the same attribute (ie. “content” or “subject name”), to jump or translate its representation to where that item is represented based upon another attribute value, whilst remaining focussed on the same item.

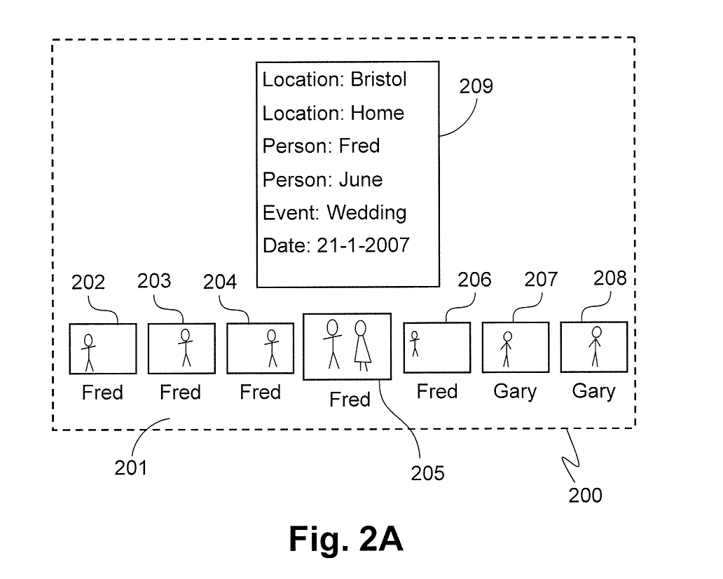

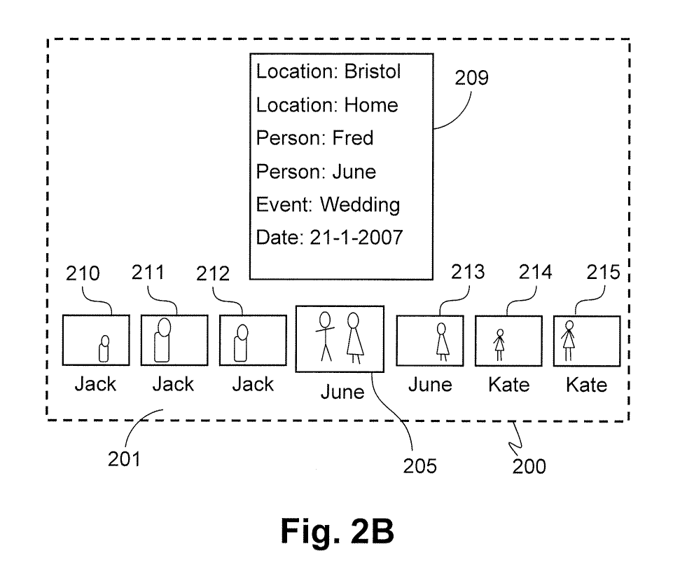

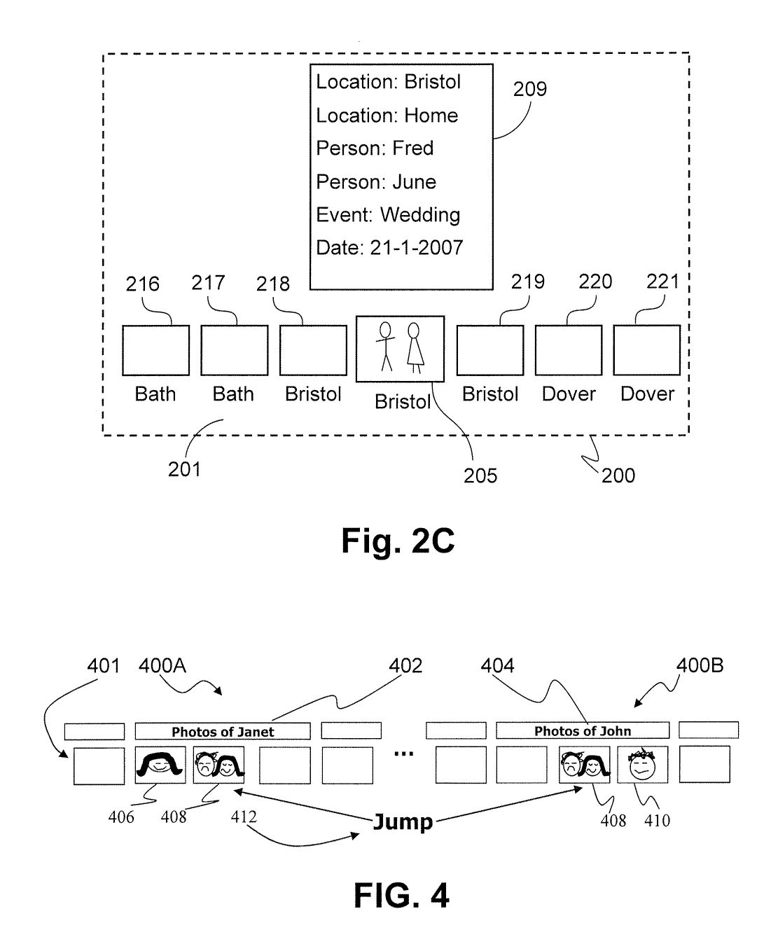

FIG. 2A shows an example screen layout 200 which may be represented upon the display 100 or 314 under control of a user controllable browser application executing upon the corresponding computer device 101 or 301. The arrangements presently disclosed, whilst able to be implemented on either platform, and many others, are particularly suited to platforms which have limited user control input, such as the system of FIG. 1 and hereafter structural and functional references will focus upon that platform. The layout 200 has an ordered list display part 201, in this case, showing a list of images 202-208 ordered alphabetically by the name of the person listed in the image attributes. The ordered list display part 201 provides a window into the whole collection listed in alphabetical name attribute order and which permits the user to scroll left or right using the input device 105 (eg. left and right arrow buttons) to move the window left or right through the list to progressively see other items in the collection. Where an item in the collection has more than one person attribute listed in the image attributes, the item appears in the list at multiple positions corresponding to each attribute value and the user can scroll between these different positions of the same item. In this fashion the user may scroll through the collection 201 from the representation of FIG. 2A to the representation of FIG. 2B noting that the same photographic image 205 appears in each of FIGS. 2A and 2B at different positions in the ordered arrangement.

The layout 200 includes a centrally located focus item 205, shown displayed in slightly larger format to permit easy identification. The central location for the focus items is desirably fixed. Above the focus item 205 is an attribute selection menu 209 which forms a graphical user interface. The attribute selection menu 209 contains a list of all the attribute values for the focus item 205. The attribute values are for each of a number of different attribute types such as Person, Location, Event and Date. In this example there is more than one attribute value listed for each of the attribute types Location and Person. In the present example, the focus item 205 is derived from the list ordered according to the Person attribute and is focussed on the representation of the item corresponding to the attribute value Fred. The menu 209 desirably is a graphical user interface in which representations of the attribute types and/or the corresponding attribute values are selectable (eg. using up and down arrow buttons and an enter button) using for example the remote control 105.

The user may select an attribute value in the attribute selection menu 209 which is of the same attribute type as that used for the displayed list order. On selecting the attribute value, the ordered list display part 201 changes to show the focus item 205 at the position in the list corresponding to the attribute value selected. The focus item 205 remains in the same position on the display but the items either side change to those items neighbouring the new position of the focus item 205 in the list. FIG. 2B shows an example of what is displayed when the attribute value ‘June’ is selected in FIG. 2A. This operation is referred to herein as ‘jumping’ as the list 201 shown remains in the same (alphabetical) order and the user jumps to a different point in the list 201, in this case spanning images 210, 211, 212, 205, 213, 214 and 215. Note that during the jump operation, the display changes substantially instantaneously form FIG. 2A to FIG. 2B, and the focus item 205 remains the same as does the attribute selection menu 209. The focus item 205 now is shown amongst the images 210-212 and 213-215 centred upon the other Person attribute value June. Alternatively, if the user chooses, the user can simply scroll the images in the collection to the new position as shown in FIG. 2B, viewing the rest of the collection along the way.

For the jump function, the substantially instantaneous change of the display representation may be implemented by an instantaneous change of the display, or alternatively by an automated fast animated traversal from the first instance of the focus image item 205 to the second instance of the focus image 205. The automated fast animated traversal may be used to present a contextual relationship of the two instances to the user.

The user may also select an attribute value in the attribute selection menu 209 which is of a different attribute type to that used for the displayed list order. On selecting the attribute value, the ordered list display part 201 changes to show the list ordered by the attribute type of the selected attribute value with the focus item 205 at the position in the list corresponding to the attribute value selected. The focus item 205 remains in the same position on the display but the items either side of the focus item 205 change to those items neighbouring the new position of the focus item 205 in the re-ordered list. FIG. 2C shows an example of what is displayed when the attribute value corresponding to the location ‘Bristol’ is selected in FIG. 2A. This operation is referred to herein as ‘pivoting’. Note that pivoting is different to ‘jumping’ as the list 201 changes to show the list in a different order (here ordered according to Location name). Note that the user would not be able to scroll from the displayed subset of items in FIG. 2A to the displayed subset of items shown in FIG. 2C. As such pivoting performs a function not able to be performed by traditional scrolling. Further pivoting function presently disclosed operates on image collections in the presence of images having multi-value attributes.

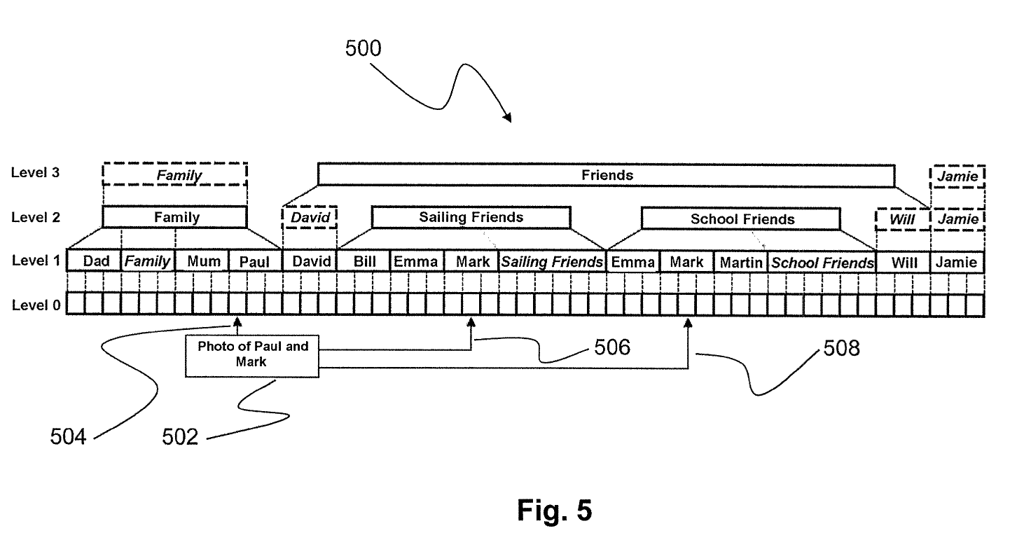

FIG. 5 shows a collection 500 of photographs having a number of levels, where the actual photographs reside at Level 0, and structural and organizational information regarding the collection 500 appears at Level 1, Level 2 and Level 3. The structure may be represented by a hierarchical tree but is distinguished from a traditional tree structure in that it is not essential to traverse the tree structure (ie. up/down through nodes) to change between items or levels. The levels form an attribute value hierarchy that is mapped to a set of ordered lists (or arrangements) of groups representing different levels of the hierarchy. Groups/items at each level are ordered according to the hierarchy above and then by attribute value (within the groups of the level above). A group/item is repeated in a level when it belongs to more than one group in the levels above. For example in FIG. 5 indicated is one photograph 502 including Paul and Mark, seen at Level 0. The photograph 502 is recorded in Level 0 at three instances, a first instance being at 504 (corresponding to Paul at Level 1 and Family at Levels 2 and 3), a second instance at 506 (corresponding to Mark at Level 1, Sailing Friends at level 2, and Friends at Level 3) and at a third instance 508 (corresponding to Mark at level 1, School Friends at Level 2 and Friends at Level 3). Items with no attribute value for the current level are given a value from the level above or below (eg. the Family attribute value). A preferred organisational rule is to use a value from the highest level below or, if there is none, the lowest level above. The user can scroll through the list and change levels while maintaining a current focus item. For a current focus item the user can jump between positions in the list corresponding to different attribute values at the current and higher levels in the hierarchy.

The organizational structure seen in FIG. 5 creates “duplicates” of images at level 0 corresponding to attribute values at higher levels of the hierarchy, including levels higher than the next level up. When browsing, a user will need information about the context of levels above in order to make sense of scrolling and jumping operations.

At Level 0, all the individual items are displayed with “duplicates” when an item has multiple values for the current attribute. The photo of Paul and Mark is found in 3 places at Level 0, once for each of Paul and Mark and then a third because the whole collection of Mark items is found under Sailing Friends and School Friends (because Mark is apparently both). At Level 1 the groups displayed are: Dad, Family, Mum, Paul, David, Bill, Emma, Mark, Sailing Friends, Emma, Mark, Martin, School Friends, Will, Jamie. Note that Sailing Friends and School Friends are shown in italics because the items in these groups have no attribute value for this level, and inherit the value from the level above, since there is no value in a level below. At Level 2 the groups displayed are Family, David, Sailing Friends, School Friends, Will, Jamie. Note that David, Will and Jamie are in italics because they have no attribute at this level and inherit the attribute from the level below. At Level 3 the groups displayed are Family, Friends, Jamie. Note again Family is in italics because it has no attribute at this level and inherits the attribute from the level below. Items at each level are sorted according to the hierarchy above and then alphabetically or numerically by attribute value within the groups of the level above.

For jumping operations, if a user is scrolling the collection 500 at Level 0 and the focus item is the photo 502 of Paul and Mark, then the user is able to jump between the photo at any of the three points 504, 506 and 508 in the list. The user may also pivot to other sort orders, such as Paul/Family, Mark/Sailing Friends or Mark/School Friends. If the user is at Level 1 and the focus item is the photo 502 of Paul and Mark, the user can jump between the groups for Paul/Family, Mark/Sailing Friends or Mark/School Friends. If the user is at Level 2, the user can jump between the groups for Family, Sailing Friends and School Friends. If at level 3, the user can jump between Family and Friends.

It will be observed from FIG. 5 that each level relates to an attribute having certain values, and that those value may in turn be attributes for the next (lower) level. Through this structure values can be sub-attributes which in turn can have values (or sub-values). For example, if Level 3 defines one attribute, Friends is a value in that attribute. Friends further has values of David, Sailing Friends, School Friends and Will. Sailing Friends, for example, is an attribute having values of Bill, Emma, Mark and Sailing Friends.

The arrangements described offer a number of advantages. Firstly, the user can quickly access any other item with any common attribute value via jumping and scrolling (and pivoting). This takes advantage of the multi-value attributes to enhance browsing/navigation. Also, the presently disclosed arrangements offer a simple navigation model, and an ability to scan a whole collection and all related items. A further advantage is that each level contains all items, either as individual items, or within a group item. Therefore it is not necessary to navigate up and down the hierarchy to get to any other item at the same level of the hierarchy. A further advantage is that a number of lists for different hierarchical levels are offered where all items are represented and which can be automatically generated from supplied or looked up (assessed) relationships between various attribute values. This contrasts prior arrangements that have a predefined hierarchy.

The arrangements described and organisational structures may be extended in a variety of ways, such as:
(i) Instead of showing groups items for levels, show all items in a group without duplicates in levels below;
(ii) Using different mappings of hierarchy tree to set of lists, such as:
   (ii-a) Using different rules to set attribute values where none are supplied for current level. eg. use a value from level above, and if none, from level below;
   (ii-b) Other methods of ordering items within groups/hierarchy;
   (ii-c) Method of equalizing group sizes in a level (or optimizing some other parameter) by moving groups up levels in the hierarchy where the tree is shorter than the tallest part of hierarchy or possibly adding more levels to the hierarchy to help achieve this;
(iii) Once an attribute value is known to have related values at a higher level in the hierarchy, the higher level annotation can be inferred from the lower level annotation. This rule however need not be applied;
(iv) Duplicates need only be used for Level 1 annotations. Groups are not duplicated but rather listed under their primary attribute value in the level(s) above;
(v) Indicating in the user interface (UI) the current position in the hierarchy, eg. at Level 0 looking at the photo of Paul and Mark under Friends/Sailing Friends;
(vi) Methods of displaying and selecting pivot options in the UI;
(vii) Extend to combinations of attributes; and
(viii) Filtering of the structure to remove items from consideration.

FIG. 6 shows a flowchart of a method 600 which is preferably stored with and executed by a computer device, such as the devices 101 or 301 and which provides for browsing of a collection of data items in which one or more items have multiple values for the same data attribute. Items also desirably have multiple attributes. The method 600 has a nominal entry step 602, which may represent the method 600 being a sub-program or sub-routine of a larger software application. In a first substantive step 604, the browsing application identifies one item of the collection as a focus item and sorts the items in the collect according to an attribute type associated with the focus item. This creates an ordered list of the items in the collection. Step 606 then operates to display a subset of the items in the list including and preferably centred upon the focus item. Step 606 also operates to display a summary of attribute data preferably including attribute types and corresponding attribute values. This may give a representation for example corresponding to that of FIG. 2A.

Step 608 then operates to detect user input, for example via a limited user input device such a remote control or that found on portable appliances. Step 610 tests any detected user input to determine if a scroll command was input. If so, step 612 then advances the focus item to the next item, in the ordered list in the direction of scroll and then returns control to step 606 whereupon the subset including the new focus item are displayed.

If a scroll command is not detected at step 610, step 614 then tests to determine if an attribute value selection command was input by the user. If not, then the method 600 returns via a path 601 to step 606 to maintain the present display. If so, step 616 checks whether the selected attribute value is of the same type as the attribute type for which the list is currently sorted.

If step 616 finds that the value is of the same type, the input is interpreted as a “jump” command and the list is repositioned according to step 618 to the location of the focus item in the same sorted list corresponding to the “another” corresponding attribute value. As such, where an item has multiple attribute values for the currently sorted attribute, that item will appear in multiple instances in the current sorted list. Once the focus item is repositioned, the method 600 returns to step 606 where the subset is displayed corresponding to the new focus item. This is equivalent to that shown in FIG. 2B.

If step 616 finds that the value is not of the same type this is a “pivot” command and step 622 operates to change the sort order of the items according to the attribute type of the attribute value selected and positions the list corresponding to the selected attribute value. The method 600 returns to step 606 wherein the new subset and focus item are displayed. This is equivalent to that shown in FIG. 2C.

### INDUSTRIAL APPLICABILITY

The arrangements described are applicable to the computer and data processing industries and particularly for the navigation of collections of image data items where the image data items may have more than one attribute value

The foregoing describes only some embodiments of the present invention, and modifications and/or changes can be made thereto without departing from the scope and spirit of the invention, the embodiments being illustrative and not restrictive.

We claim:

1. A method of browsing a collection of images represented on a display device, said method comprising the steps of:
(i) providing an ordered arrangement of said images according to at least one specific attribute of said images wherein at least one of said images has multiple values for said at least one attribute and said one image appears in said arrangement at a first position corresponding to a first of said values and at least one second position corresponding to at least a second of said values;
(ii) displaying at least a first subset of said arrangement of images on the display device, said first subset including said one image at said first position; and
(iii) responding to a user action upon an input device to cause display on the display device of a second subset of said arrangement of images including said one image at one said second position.

2. A method according to claim 1 wherein said user action relates to a directional movement and step (iii) comprises scrolling the display progressively through the arrangement of said images from said one image at said first position to said one image at one said second position.

3. A method according to claim 1 wherein said user action relates to a jump function and step (iii) comprises changing the display substantially instantaneously from a display of the first subset of images to a display of the second subset of images.

4. A method according to claim 3 wherein the changing of the display is instantaneous.

5. A method according to claim 3 wherein the changing of the display comprises an automated fast animated traversal from the first subset to the second subset of images.

6. A method of browsing a set of images represented on a display device, said method comprising the steps of:
(i) providing an ordered arrangement of said images according to a specific attribute of said images wherein at least one of said images which has multiple values for said attribute and said one image appears in said arrangement at a first position corresponding to a first of said values and at a second position corresponding to a second of said values;
(ii) displaying at least a subset of said arrangement on the display device;
(iii) responding to a user action initiating directional movement for scrolling said arrangement such that the user can scroll between said first and said second positions of said one image.

7. A method of browsing a set of images displayed on a display device, said method comprising the steps of:
(i) providing an ordered arrangement of said images according to a specific attribute of said images wherein at least one of said images, which has multiple values for said attribute, appears in said arrangement at a first position corresponding to a first of said values and at a second position in said arrangement corresponding to a second of said values;
(ii) displaying at least a first subset of said arrangement on the display device including said one image at said first position in said arrangement being displayed at a location in the display;
(iii) responding to a user action by changing the display to display a second subset of the arrangement such that said one image is at substantially the same location in the display and the second subset includes said second position of said one image.

8. A method according to claim 7 wherein said location is a fixed focus location in the display.

9. A method according to claim 7 further comprising the step of:
(iv) responding to a second user action initiating directional movement for scrolling said arrangement such that the user can scroll between said second and said first positions of said one image.

10. A method according to claim 7 further comprising the step of:
(iv) responding to a user action by changing the displayed subset of the arrangement such that said one image is at substantially the same location in the display and that other images displayed in the display correspond to the position of said one image in a second arrangement of the set ordered by a further specific attribute of said images.

11. A method according to claim 1 wherein said ordered arrangement comprises a circular list.

12. A method according to claim 3 further comprising the step of:
displaying, in association with said one image on the display device, a representation of values of said attributes associated with said one image.

13. A method according to claim 12 wherein the representation of said values forms a user selectable menu via which a value of one said attribute is selectable by said user action for said one image.

14. A user interface for representing a set of images having attributes, at least one of said images having multiple values associated with at least one of said attributes, said interface comprising:
an arrangement of said images of said set ordered according to said at least one attribute;
a first display representation displayable upon a display device of a first subset of said ordered arrangement, the first subset including said one image at a first position in said ordered arrangement;
means for receiving user input; and
a second display representation displayable upon the display device of a second subset of said ordered arrangement, said second subset including said one image at a further position.

15. A user interface according to claim 14 wherein said further position is one of a position in said ordered arrangement or a position in a further ordered arrangement of said images ordered according to a further one of said attributes.

16. A user interface according to claim 14 wherein said means for receiving said user input is selected from the group consisting of a mouse pointer device, a keyboard, a keypad of a remote control device and a graphical user interface forming part of said display representation.

17. A user interface according to claim 14 further comprising at least one user selectable menu associated with said one image, said menu including representations of values of attributes associated with said one image wherein at least one of the values is a sub-attribute having a corresponding sub-value thereby defining associable groups and levels of images in said collection.

18. A computer readable medium having a computer program recorded for browsing a collection of images represented on a display device, said program comprising:
code means for providing an ordered arrangement of said images according to at least one specific attribute of said images wherein at least one of said images has multiple values for said at least one attribute and said one image appears in said arrangement at a first position corresponding to a first of said values and at least one second position corresponding to at least a second of said values;
code means for displaying at least a first subset of said arrangement of images on the display device, said first subset including said one image at said first position; and
code means for responding to a user action upon an input device to cause display on the display device of a second subset of said arrangement of images including said one image at one said second position.

19. Computer apparatus for browsing a collection of images represented on a display device, said apparatus comprising:
means for providing an ordered arrangement of said images according to at least one specific attribute of said images wherein at least one of said images has multiple values for said at least one attribute and said one image appears in said arrangement at a first position corresponding to a first of said values and at least one second position corresponding to at least a second of said values;
means for displaying at least a first subset of said arrangement of images on the display device, said first subset including said one image at said first position; and
means for responding to a user action upon an input device to cause display on the display device of a second subset of said arrangement of images including said one image at one said second position.
